(19) United States
(12) Patent Application Publication
(10) Pub. No.: US 2025/0118479 A1
(43) Pub. Date: Apr. 10, 2025

(54) PERMANENT MAGNET HYBRID CORE MAGNETICS

(71) Applicants: The Trustees of Dartmouth College, Hanover, NH (US); Massachusetts Institute of Technology, Cambridge, MA (US); Murata Manufacturing Co., Ltd., Kyoto (JP)

(72) Inventors: Charles R. Sullivan, Hanover, NH (US); David J. Perreault, Cambridge, MA (US); Rachel S. Yang, Cambridge, MA (US); Andrew B. Nadler, Hanover, NH (US); David Giuliano, Bedford, NH (US)

(21) Appl. No.: 18/983,181

(22) Filed: Dec. 16, 2024

Related U.S. Application Data
(63) Continuation of application No. PCT/US2023/025632, filed on Jun. 16, 2023.
(60) Provisional application No. 63/366,620, filed on Jun. 17, 2022.

(51) Int. Cl. H01F 27/255

(52) U.S. Cl. CPC H01F 27/255

(57) ABSTRACT

Disclosed embodiments may include systems and methods of a permanent magnet (PM) hybrid core inductor and fabrication methods thereof. The permanent magnet hybrid core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines. Some embodiments may include an inductor comprising the permanent magnet hybrid core, or a power conversion circuit including a switched capacitor circuit and a switching regulator, the switching regulator including an inductance, the inductance comprising an electrical conductor wound around a permanent magnet hybrid core.

### CROSS-REFERENCE TO RELATED APPLICATIONS

This application is a continuation of International Patent Application No. PCT/US2023/025632 filed Jun. 16, 2023 and entitled “PERMANENT MAGNET HYBRID CORE MAGNETICS,” which claims priority to and the benefits of U.S. Provisional Patent Application No. 63/366,620 filed Jun. 17, 2022 and entitled “PERMANENT MAGNET HYBRID CORE MAGNETICS,” all of which are incorporated herein by reference in their entirety.

### TECHNICAL FIELD

The present disclosure generally relates to power electronics devices. More particularly, the present disclosure relates to voltage converters and/or regulator devices with high energy storage and low conduction losses.

### BACKGROUND

With the advancements in integrated circuit technologies and computing capabilities, there is a commensurate growth in the demand for power conversion, regulation, and its management. For power electronics devices such as converters or input filters operating in continuous conduction mode at large de current, an inductor's storage density may be enhanced by using a core material with high saturation flux density. However, for high-frequency operation in the range of MHz and above, conduction and core losses may also increase with the applied de bias, thereby limiting the performance of inductors. While ferrites exhibit low core losses at high frequencies, they suffer from low saturation flux densities. Therefore, it may be desirable to provide an inductor design with high energy storage, high saturation flux, low de conduction losses, and/or low ac-related losses including low ac conduction losses.

### SUMMARY

Embodiments of this disclosure provide a permanent magnet (PM) hybrid core inductor and fabrication methods thereof. One aspect of this disclosure is directed to a magnetic core. The magnetic core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines.

Another aspect of this disclosure is directed to a magnetic core. The magnetic core may include a permanent magnet having a curved surface, and a soft magnetic member located adjacent to the curved surface of the permanent magnet. The soft magnetic member may form a first gap between two end faces of the soft magnetic member and may provide a hollow space for winding an electrical conductor around the permanent magnet. The permanent magnet may provide at least a partially parallel path to the soft magnetic member for flow of magnetic flux lines.

Yet another aspect of this disclosure is directed to an inductor. The inductor may include an electrical conductor wound around a magnetic core. The magnetic core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines.

Yet another aspect of this disclosure is directed to an inductor. The inductor may include an electrical conductor wound around a magnetic core. The magnetic core may include a permanent magnet having a curved surface, and a soft magnetic member located adjacent to the curved surface of the permanent magnet. The soft magnetic member may form a first gap between two end faces of the soft magnetic member and may provide a hollow space for winding an electrical conductor around the permanent magnet. The permanent magnet may provide at least a partially parallel path to the soft magnetic member for flow of magnetic flux lines.

Yet another aspect of this disclosure is directed to an apparatus. The apparatus may include a switching voltage regulator including an inductance. The inductance may include an electrical conductor wound around a magnetic core. The magnetic core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines.

Yet another aspect of this disclosure is directed to an apparatus. The apparatus may include a switching voltage regulator including an inductance. The inductance may include an electrical conductor wound around a magnetic core. The magnetic core may include a permanent magnet having a curved surface, and a soft magnetic member located adjacent to the curved surface of the permanent magnet. The soft magnetic member may form a first gap between two end faces of the soft magnetic member and may provide a hollow space for winding an electrical conductor around the permanent magnet. The permanent magnet may provide at least a partially parallel path to the soft magnetic member for flow of magnetic flux lines.

Yet another aspect of this disclosure is directed to an apparatus. The apparatus may include a power conversion circuit including an inductance. The inductance may include an electrical conductor wound around a magnetic core. The magnetic core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines.

Yet another aspect of this disclosure is directed to an apparatus. The apparatus may include a power conversion circuit including an inductance. The inductance may include an electrical conductor wound around a magnetic core. The magnetic core may include a permanent magnet having a curved surface, and a soft magnetic member located adjacent to the curved surface of the permanent magnet. The soft magnetic member may form a first gap between two end faces of the soft magnetic member and may provide a hollow space for winding an electrical conductor around the permanent magnet. The permanent magnet may provide at least a partially parallel path to the soft magnetic member for flow of magnetic flux lines.

Yet another aspect of this disclosure is directed to an apparatus. The apparatus may include a power conversion circuit including a switched capacitor circuit and a switching regulator, the switching regulator including an inductance, the inductance comprising an electrical conductor wound around a magnetic core. The magnetic core may include a first set of members comprising a soft magnetic material, the first set of members forming a first gap between two end faces of the first set of members, and a second set of members comprising a permanent magnetic material and located adjacent to the first set of members, wherein the second set of members provides at least a partially parallel path to the first set of members for flow of magnetic flux lines.

Yet another aspect of this disclosure is directed to an apparatus. The apparatus may include a power conversion circuit including a switched capacitor circuit and a switching regulator, the switching regulator including an inductance, the inductance comprising an electrical conductor wound around a magnetic core. The magnetic core may include a permanent magnet having a curved surface, and a soft magnetic member located adjacent to the curved surface of the permanent magnet. The soft magnetic member may form a first gap between two end faces of the soft magnetic member and may provide a hollow space for winding an electrical conductor around the permanent magnet. The permanent magnet may provide at least a partially parallel path to the soft magnetic member for flow of magnetic flux lines.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 is a schematic illustration of an exemplary multi-level power converter circuit, in accordance with some embodiments of the present disclosure.

FIG. 2 illustrates representations of an exemplary response (solid line) and a desirable response (dotted line) of a magnetic material to an external magnetic field, in accordance with some embodiments of the present disclosure.

FIG. 3 is a schematic illustration of an exemplary inductor design with a permanent magnet hybrid core, in accordance with embodiments of the present disclosure.

FIG. 4 is a schematic illustration of an exemplary magnetic circuit model for the permanent magnet hybrid core, in accordance with embodiments of the present disclosure.

FIGS. 5A and 5B illustrate simulated data plots of optimum ferrite fraction and maximum flux carrying capability, respectively, of the permanent magnet hybrid core using modified and ideal models, in accordance with embodiments of the present disclosure.

FIG. 6A is a schematic illustration of an exemplary magnetic core, in accordance with embodiments of the present disclosure.

FIGS. 6B-6J are schematic illustrations of exemplary implementations of the permanent magnet hybrid core in a parallel configuration, in accordance with embodiments of the present disclosure.

FIG. 7 is a schematic illustration of an exemplary implementation of one half of a double U-shaped inductor core in a non-parallel configuration, in accordance with embodiments of the present disclosure.

FIG. 8A is a schematic illustration of a perspective view of an exemplary permanent magnet hybrid core inductor, in accordance with embodiments of the present disclosure.

FIG. 8B is a schematic illustration of a cross-section view of an exemplary permanent magnet hybrid core inductor along the cross-section A-A′ shown in FIG. 8A, in accordance with embodiments of the present disclosure.

FIG. 9 is a schematic illustration of winding and permanent magnet flux paths in an exemplary permanent magnet hybrid core inductor, in accordance with embodiments of the present disclosure.

FIG. 10 illustrates data plots representing simulated and measured saturation behavior of the permanent magnet hybrid core and pure ferrite core inductors, in accordance with embodiments of the present disclosure.

FIG. 11 illustrates exemplary data plots of measured inductance of the permanent magnet hybrid core and pure ferrite core inductors across a range of frequencies, in accordance with some embodiments of the present disclosure.

### DETAILED DESCRIPTION

The following disclosure provides many different exemplary embodiments, or examples, for implementing different features of the provided subject matter. Specific simplified examples of components and arrangements are described below to explain the present disclosure. These are, of course, mere examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the invention may allow implementation of better passive components in a power converter that may in turn ease the performance requirements on the active components such as switch components.

Various non-limiting embodiments of the present disclosure will be described with respect to embodiments in a specific context, namely a high-density and high-efficiency voltage regulation device. As used in this disclosure, the term “voltage regulator” refers to a component of the power supply unit (PSU) configured to convert an input voltage to a stable output voltage. While most voltage regulators may be used for DC-DC power conversion, some voltage regulators may be used for AC-DC or AC-AC power conversion as well. A linear voltage regulator may be configured to output a lower, stable voltage signal from a higher voltage signal. In some cases, a linear voltage regulator may utilize an input and an output capacitor, or an active pass device, such as a bipolar junction transistor (BJT) or a metal-oxide semiconductor field effect transistor (MOSFET), to regulate the voltage. A switching voltage regulator, however, may be configured as a Step-Down (buck converter), a Step-Up (Boost converter), or a Buck-Boost Converter, with the help of additional external components, such as inductors, capacitors, FETs, or feedback resistors.

A power converter, in some cases, may be used as a voltage regulator. The concepts in the disclosure may apply to voltage regulators or power converters. Power converters which convert a higher input voltage power source to a lower output voltage level may be referred to as step-down or buck converters, because the converter is “bucking” the input voltage. Power converters which convert a lower input voltage power source to a higher output voltage level may be referred to as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments of the present disclosure, a power converter may be bi-directional, being either a step-up or a step-down converter depending on how a power source is connected to the converter. In some embodiments, an AC-DC power converter can be built up from a DC-DC power converter by, for example, first rectifying an AC input voltage to a DC voltage and then applying the DC voltage to a DC-DC power converter. It is to be appreciated that the permanent magnet hybrid core may be used for other forms of AC-DC, DC-AC and AC-AC power conversion as well.

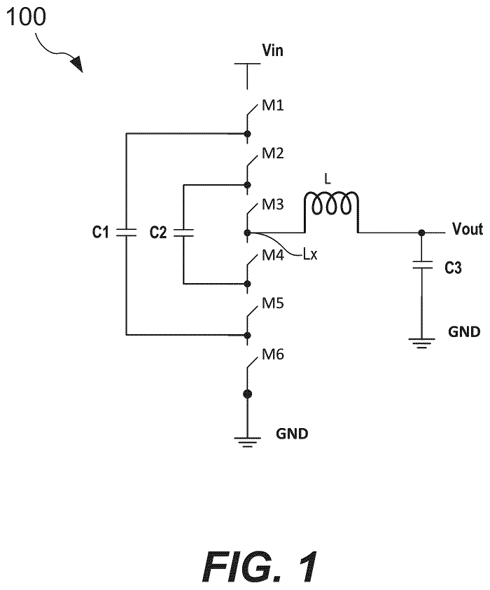

A voltage regulator or a power converter may be a switched capacitor power converter. FIG. 1 illustrates a hybrid switched capacitor power converter 100 which may be, for example, a multi-level buck power converter. Switched capacitor power converter 100 may include switches M1, M2, M3, M4, MS, and M6 arranged in a series connection, flying capacitors C1 and C2, an inductor, which may be a low-profile chip inductor having a compact size, an output capacitor C3, and a control/driver circuitry (not illustrated) configured to control switches (e.g., on or off, etc), for example. Particularly, each phase leg within the 4-level converter includes 3 cells connected in series, where each cell includes a complimentary switch pair (e.g., switches M1 and M6, switches M2 and MS, and switches M3 and M4) and an associated flying capacitor (e.g., C1 or C2). During the circuit operation, one switch is conducting in each cell at a given time. Accordingly, the multi-level power converter circuit I 00 may operate at one of eight different states. Depending upon the state, the voltage at an inductor node Lx may be at 4 different levels. To convert the voltages efficiently, a buck converter may rely on the inductor to store the energy while converting it from a higher voltage to a lower voltage.

As previously discussed, voltage regulators, such as switching voltage regulators, may rely in part on capacitors and inductors to fulfil the power conversion requirements. The inventors here have recognized, however, that for power electronics devices with large de currents and high-frequency operation, the inductors may suffer from drawbacks related to size, conduction or core losses, or current-carrying capabilities. Though the energy storage density of an inductor may be increased by using a core material having high saturation flux density, the associated core losses also increase, rendering the devices inefficient. The core losses may be exaggerated at higher frequencies (MHz and above) and with increasing de bias. While the existing inductors may include ferrite cores, which have low core losses at high frequencies, the saturation flux densities are also lower, limiting the de performance of the inductors. Therefore, it may be desirable to provide inductors with higher saturation flux density, lower core losses, and high relative permeability to allow higher current density through the inductors at high frequencies.

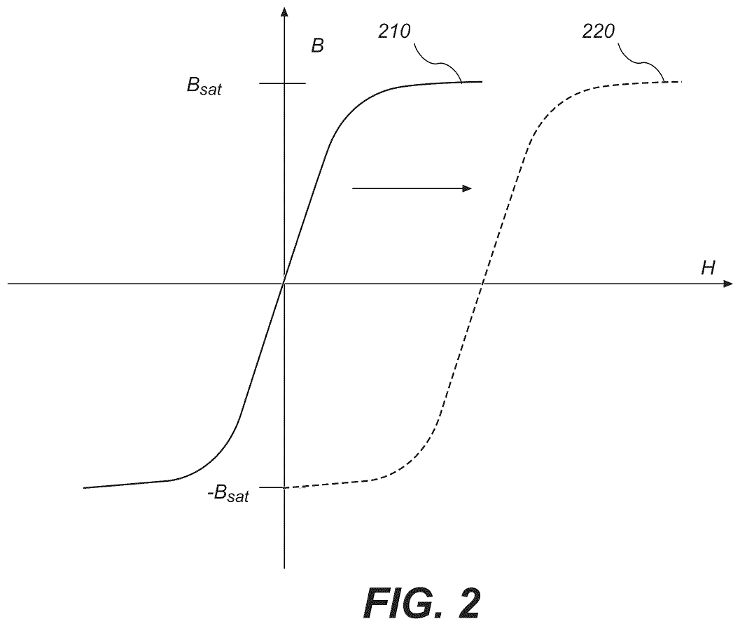

Although currently used ferrites have low saturation flux densities, the inventors have recognized that inductor designs underutilize the available saturation flux density range of the core material. Plot 210 of FIG. 2 illustrates a saturation behavior of a core material, such as ferrite, on a B-H curve or a magnetization curve. It is to be appreciated that the hysteresis effect is omitted from the magnetization curves shown in FIG. 2 for illustrative purposes only. For de-based applications, the current, and therefore the magnetizing field (H) may be non-negative, indicating that the core may only operate on the positive side of the B-H curve, thereby only utilizing half of the available saturation flux density. However, if the B-H curve could be offset, such as represented by plot 220 of FIG. 2, such that the reverse saturation starts at a more positive magnetizing field (H) or current, the core may utilize a greater range of saturation flux densities in de-based applications. Additionally, or alternatively, if the reverse saturation can be set to start at H=0 or zero current, the core could use the entire range of saturation flux density, from −Bsat to Bsat. Certain disclosed embodiments may address these and other challenges.

In various embodiments of the present disclosure, inductor designs with a permanent magnet hybrid core may be disclosed. A “hybrid core,” in the context of this disclosure refers to a core of an inductor which comprises a soft magnetic material and a permanent magnetic material. A soft magnetic material may include, but is not limited to, a ferrite or a powder core material. A permanent magnetic material may include, but is not limited to, neodymium iron boron (NdFeB). The disclosed inductor configurations can provide high peak energy storage, low de conduction losses, low ac-related conduction and core losses. The permanent magnet hybrid core inductors may be desirable in applications including, but not limited to, portable electronic devices such as tablets, cell phones, or hand-held computers, IoT (Internet of Things) devices, or applications with large de flux and high-frequency flux ripple.

Some existing inductor designs include permanent magnets to improve saturation performance of the inductor core. However, the permanent magnets are placed directly in the winding flux path such as, in the gap, for example, or directly in the path of a significant portion of the winding flux, such as, adjacent to the gap. Placing the permanent magnets in the winding flux path may incur ac-losses in the permanent magnet, which increase with the operation frequency, and may demagnetize the permanent magnets at large currents.

Reference is now made to FIG. 3, which is a schematic illustration of an exemplary permanent magnet hybrid core, in accordance with some embodiments of the present disclosure. FIG. 3 shows a perspective view of an exemplary magnetic core 300 which may include a soft magnetic material 310 and a permanent magnetic material 320, a coil 330 wound continuously around the core. In some embodiments, magnetic core 300 may include a first magnetic member comprising soft magnetic material 310. The first magnetic member may form a first gap 312 between two end faces of the first magnetic member. The magnetic core may further include a second magnetic member comprising permanent magnetic material 320. The second magnetic member may form a second gap 322 between two end faces of the second magnetic member. In some embodiments, permanent magnetic material 320 may be located adjacent to soft magnetic material 310 such that permanent magnetic material 320 provides at least a partially parallel path or a substantially parallel path to the first magnetic member for flow of magnetic flux lines. In such a configuration, the flow of magnetic flux lines in permanent magnetic material 320 may oppose the flow of magnetic flux lines in soft magnetic material 310 induced by electrical current flowing through coil 330 wound around soft magnetic material 310, permanent magnetic material 320, or both. The opposing magnetic flux lines in permanent magnetic material 320 to the magnetic flux lines in soft magnetic material 310 may cause the B-H curve to offset, resulting in a higher effective saturation flux, higher peak energy storage, and lower conduction losses. In the context of this disclosure, “opposing flow” of flux lines refers to the directionally opposite flow of magnetic flux lines between two magnetic members. As an example, if the magnetic flux lines flow in a clockwise direction in soft magnetic material, the direction of magnetic flux lines in the permanent magnetic material may be counter-clockwise.

In some embodiments, magnetic core 300 may comprise a first set of magnetic members, a second set of magnetic members, and an electrical conductor (e.g., coil 330) wound around one or both magnetic members. A “magnetic member,” as used herein refers to a monolithic structure or an assembled structure of two or more components. As an example, an assembled U-shaped magnetic member may include three rectangular pieces coupled such that they form a substantially continuous shape with a small gap, if any, in the connection between the pieces. A “set” of magnetic members, as used herein, refers to a plurality of magnetic members, placed in parallel or in series, such that the magnetic members form a single substantially continuous magnetic member.

In some embodiments, first gap 312 may be filled with a material having low electrical conductivity. In some embodiments, first gap 312 may be filled with a material having a low relative magnetic permeability. In the context of this disclosure, “relative magnetic permeability” refers to a ratio of the magnetic permeability of a specific medium to the magnetic permeability of free space or vacuum. In a preferred embodiment, first gap 312 may be filled with a material having magnetic permeability lower than magnetic permeability of soft magnetic material 310. In some embodiments, first gap 312 may be filled with a material including, but not limited to, a polymer, a ceramic, or any suitable material having low electrical conductivity and low relative magnetic permeability. It is to be appreciated that although FIG. 3 illustrates an exemplary magnetic core design with two gaps, there may be more gaps corresponding to the number of magnetic members, for example.

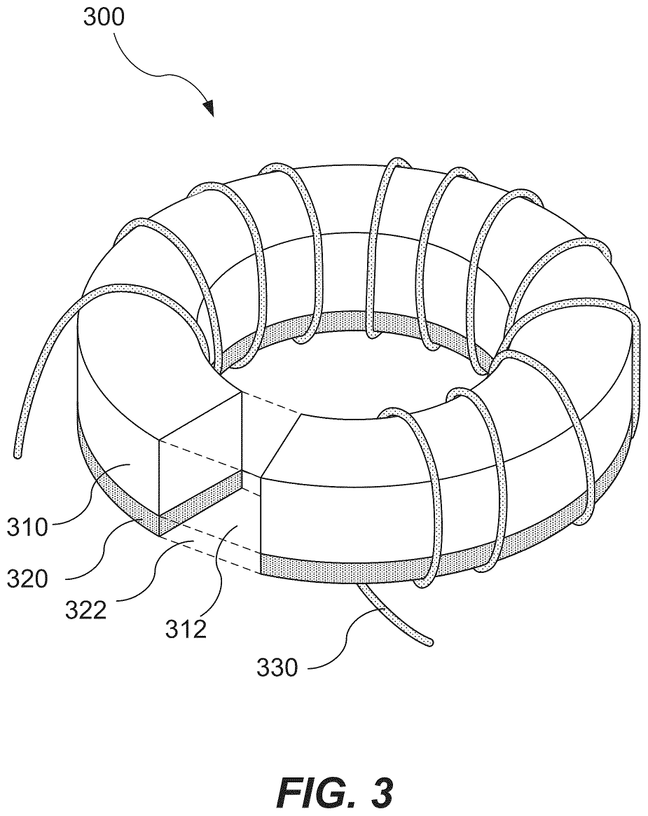

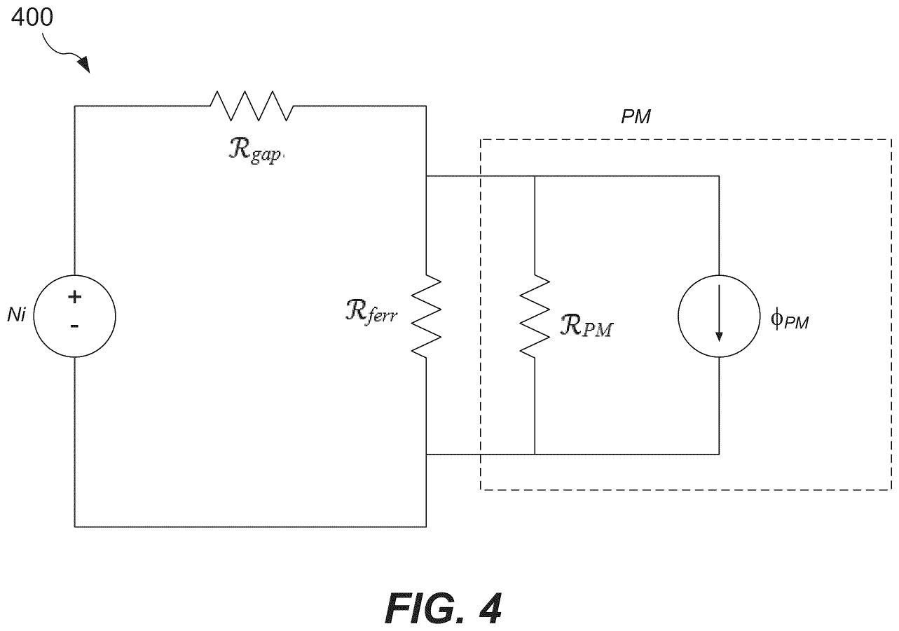

In some embodiments, second gap 322 may be analogous to first gap 312. Second gap 322 may be filled with a material having low electrical conductivity, low relative magnetic permeability, or both. In some embodiments, second gap 322 may be filled with a material including, but not limited to, a polymer, a ceramic, or any suitable material having low electrical conductivity and low relative magnetic permeability. In some embodiments, second gap 322 may adjoin first gap 312, as illustrated in FIG. 3. In practice, however, the two gaps, 322 and 312 may function as a single gap, as illustrated in the magnetic circuit diagram in FIG. 4 (discussed later), because there is nothing blocking the flux from either soft magnetic material 310 or permanent magnetic material 320 from flowing through the gaps 312 or 322.

In some embodiments, coil 330 may include a spirally wound coil made of an electrically conducting material such as, but not limited to, copper, aluminum, silver, titanium, an alloy, or other suitable electrically conducting materials. In a preferred embodiment, coil 330 may be made of copper. In some embodiments, coil 330 may be continuously wound around soft magnetic material 310, or permanent magnetic material 320, or both.

As shown in FIG. 3, permanent magnetic material 320 may be disposed parallel to and abutting soft magnetic material 310. In some embodiments, permanent magnetic material 320 may be placed such that a top surface of permanent magnetic material 320 abuts a bottom surface of soft magnetic material 310 and the top surface of permanent magnetic material 320 is physically in contact with at least a portion of bottom surface of soft magnetic material 310, to maintain low magnetic reluctance, among other things.

Reference is now made to FIG. 4, which illustrates an exemplary magnetic circuit model 400 for magnetic core 300, in accordance with some embodiments of the present disclosure. As shown, reluctance of the ferrite 'R_{ferr} and reluctance of permanent magnet 'RPM are parallel to each other, consistent with FIG. 3. Model 400 further includes a magnetomotive force (MMF) source Ni. In circuit model 400, magnetic core 300 may have a total core area Ac, of which the soft magnetic material (e.g., ferrite) may be a fraction F1 and the permanent magnetic material may be (1-FJ). Although FIG. 4 illustrates a Norton circuit model for the permanent magnet, other suitable circuit models may be used as well. Using the Norton model, the permanent magnet may be modeled with a reluctance having a permeability approximately equal to μ₀, and a current source set by the permanent magnet's remanent flux density, Bᵣ and cross-sectional area APM—The maximum flux that the permanent magnet portion of magnetic core 300 may carry, can be represented as:

$$Φ P M = {B}_{r} {A}_{c} ( 1 - {F}_{f} ) \qquad Eq . l$$

The maximum flux that the ferrite part of magnetic core 300 may carry, can be represented as:

$${ϕ}_{f e r r} = {B}_{max} {A}_{c} {F}_{f} \vert \qquad Eq . 2$$

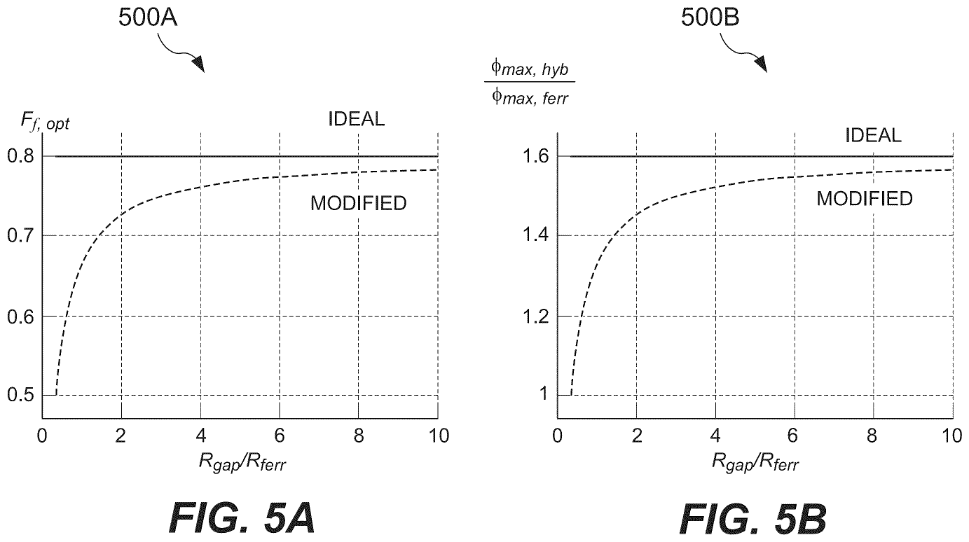

With reference to FIG. 4, the ferrite may be assumed to have a permeability sufficiently larger than the permeability of the permanent magnet such that 'Rferr<<'R_{PM} and that the gap dominates the winding reluctance path such that 'Rferr<<'Rgap. The winding flux from the MMF source, Ni, may primarily flow through the gap and the ferrite, and the permanent magnet flux may flow primary through the ferrite in the opposite direction, thereby offsetting the total de flux in the ferrite while avoiding the winding flux. It may be assumed, under ideal circumstances, substantially all of the permanent magnet flux may return through the ferrite. This is referred to as an ideal model. In some embodiments, however, a portion of the permanent magnet flux may return through the ferrite (discussed later with reference to FIG. 5), which is referred to as a modified model.

Based on circuit model 400, first-order results for the maximum flux carrying capability for magnetic core 300 may be determined. For example, for a fixed core area Ac in magnetic core 300, the maximum achievable flux may be adjusted based on the fraction of ferrite F1 used. In general, as the fraction of ferrite is reduced, and the fraction of permanent magnet is increased, more permanent magnet flux may be available to oppose the winding flux in the ferrite, thereby increasing the flux carrying capability of magnetic core 300. This may be mathematically represented as:

$${ϕ}_{max , hybrid} = {B}_{max} {A}_{c} {F}_{f} + {B}_{r} {A}_{c} ( 1 - {F}_{f} ) \qquad Eq . 3$$

where Φmax,hybrid is the maximum flux carried by the hybrid magnetic core 300.

In some embodiments, for the permanent magnet to improve the saturation characteristics of the hybrid magnetic core (e.g., magnetic core 300), the remanent flux density Bᵣ of the permanent magnet may be greater than the saturation flux density of the ferrite, Bmax. This is because the permanent magnet hybrid core would otherwise by trading a fraction of ferrite for a permanent magnet material with inferior flux capability characteristics, rendering the hybrid design inefficient. Therefore, based on Eq. 3, for a large P max, hybrid, the fraction of ferrite area may be small. But Eq. 3 only considers the permanent magnet hybrid core's saturation behavior at large currents and not at small currents, where the permanent magnet flux may reverse saturate the ferrite. In some applications, it may be desirable to prevent reverse saturation at zero current and above. In such cases, the permanent magnet flux may not exceed the ferrite's maximum flux capability, or ΦPM=BₘₐₓA_{c}F_{f}.

However, to maximize the permanent magnet hybrid core's flux carrying capability, the largest possible permanent magnet flux may be desirable. By combining the reverse saturation constraint and the bounds of Eq. 3, the maximum permanent magnet hybrid core flux may be represented as:

$${ϕ}_{P M} = 2 {B}_{max} {A}_{c} {F}_{f} \qquad Eq . 4$$

In other words, the flux carrying capability of the permanent magnetic material may be twice the flux carrying capability of the ferrite. Under such a situation, the permanent magnet may offset the ferrite's B-H curve so that a full range of saturation flux density from −Bₘₐₓ to +Bₘₐₓ, as shown in plot 220 of FIG. 2, may be utilized in de-based applications.

The fraction of ferrite area F1, that would result in optimal flux carrying capability of the permanent magnet hybrid core, may be determined based on Eq. 1 and the reverse

saturation constraint ΦPM=2BₘₐₓA_{c}F_{f}. The optimal ferrite fraction may be represented as:

$$F - {B}_{r} \\ {f}_{1} opt {B}_{r} + {B}_{max} \qquad Eq . 5$$

Combining Eqs. 3 and 5, the permanent magnet hybrid core's maximum flux carrying capability and effective saturation flux density may be determined in terms of material properties and geometries.

$$Φ max , hybrid = 2 \frac{B max}{1 + B max / Br} Ac \qquad Eq . 6$$

$$Φ sat , eff = 2 \frac{B max}{1 + B max / Br} \qquad Eq . 7$$

A comparison of the maximum achievable flux and the effective saturation flux density between a pure ferrite core and a hybrid magnetic core (e.g., magnetic core 300), based on equations 6 and 7, indicates that the permanent magnet hybrid core may achieve a

larger saturation flux and effective saturation flux density by a factor of

$$2 \frac{B max}{1 + B max / Br} .$$

As an example, if the effective saturation flux density Br for a permanent magnet such as neodymium iron boron (NdFeB) is 1.2 T, and an effective saturation flux density Bmax for a ferrite is 0.4 T, the saturation flux and the effective saturation flux density for a permanent magnet hybrid core may be 0.6 T. In some embodiments, the effective saturation flux density and the saturation flux of the permanent magnet hybrid core may be 1.2×, or 1.3×, or 1.4×, or 1.5×, or 1.6×, or greater than the effective saturation flux density and the saturation flux of a pure ferrite core.

Reference is now made to FIGS. 5A and 5B, which illustrate simulated data plots of optimum ferrite fraction and maximum flux carrying capability, respectively, of the permanent magnet hybrid core using modified and ideal models, in accordance with embodiments of the present disclosure. In some embodiments, a fraction k_{PM} of the permanent magnet flux may return through the ferrite. For example, if the core has a relatively small gap such that the reluctance of the ferrite, 'Rferr is not significantly smaller than the reluctance of the gap, 'R_{gap}, some of the permanent magnet flux may cross the gap instead. From the magnetic circuit model perspective illustrated in FIG. 4, the permanent magnet flux may be divided in its return path, with some flux flowing through the ferrite and the remainder through the gap. In such a scenario, the maximum achievable flux of the permanent magnet hybrid core may be represented as:

$$Φ max , hybrid = Φ ferr + {k}_{PM} {Φ}_{PM} \qquad Eq . 8$$

$$Φ max , hybrid = B max AcFf + kpMBrAc ( 1 - Fr ) \qquad Eq . 9$$

For the permanent magnet to improve the saturation characteristics of the ferrite core, the effective saturation flux density Br of the permanent magnet may be greater than the effective saturation flux density Bmax of the ferrite such that kPM·Br>Bmax. It is to be appreciated that as kPM→1, the modified model approaches the ideal characteristics previously discussed. Because less permanent magnet flux offsets the flux in the ferrite, a greater fraction of permanent magnet, compared to the ideal characteristics, may be desirable. Additionally, because the fraction of ferrite area may be less, the permanent magnet hybrid core in a modified model may not be able to carry as much external flux compared to the ideal characteristics, as illustrated by plot 500B of FIG. 5B.

In some embodiments, the modified model may be used to determine the lower limit of the fraction of ferrite for a set of material properties. In a permanent magnet hybrid core, for the permanent magnet to continue doing useful work, the smallest k_{PM} can be is Bmax/Br.

For a modified model, as k_{PM}→BmaxlBr, the value of F_{flopt}→0.5. For Ff<0.5, the ferrite fractions may reverse saturate at zero current. Plot 500A of FIG. 5A illustrates the optimum ferrite fraction that does not reverse saturate at zero current. Plot 500A further illustrates that as the reluctance and the gap increases, the modified model approaches the ideal characteristics. Expectedly, as the gap gets smaller, the modified permanent magnet hybrid flux capability approaches that of a pure ferrite core, and the modified optimum ferrite fraction also approaches the lower limit of 0.5. It is to be appreciated that plot 500B, illustrating the maximum flux carrying capability of the permanent magnet hybrid core is normalized to the maximum flux carrying capability of the pure ferrite core.

Permanent magnet hybrid cores such as magnetic core 300 may have numerous advantages over the existing designs of ferrite cores and may address one or more of the challenges associated with the existing ferrite-based cores in inductors used for power conversion applications, for example. A permanent magnet hybrid core may have some or all of the advantages discussed herein, among others.

i. Larger saturation flux and effective saturation flux density—The permanent magnet hybrid core has a greater flux carrying capability because the permanent magnet flux may oppose the total de winding flux in the ferrite, thereby offsetting the B-H curve for improved saturation performance while avoiding the winding flux in the permanent magnet to avoid demagnetization. High energy storage capability and low conduction losses may be associated with the higher saturation flux and effective saturation flux density.

ii. Enhanced energy storage—For a fixed de resistance and inductance, the energy storage for an inductor may be determined by the saturation current, which depends on the maximum achievable flux. The permanent magnet hybrid core may have greater energy storage compared to the pure ferrite core by a factor of:

### EShybrid ESferr

$$\frac{1 / 2 {LI}_{sat , hybrid}^{2}}{1 / 2 Ll {2}_{sat , ferr}} \\ \frac{{Φ}_{max , hybrid}^{2}}{{Φ}_{max , ferr}^{2}} - {( \frac{2 {B}_{r}}{{B}_{r} + {B}_{max}} )}^{2} \qquad Eq . 10$$

As an example, if the Br=1.2 T and Bmax=0.4 T, the permanent magnet hybrid core may achieve 2.25× greater energy storage compared to the ferrite core at a fixed de resistance and inductance, as determined based on Eq. 10.

In some embodiments, the permanent magnetic hybrid core may achieve 1.5× greater maximum energy storage compared to the ferrite core at a fixed de loss. In de-based applications, the fixed de loss may be substantially similar to the total loss and may also be a good approximation for a fixed temperature rise constraint.

iii. Lower de Resistance—The de resistance for a core may be determined based on the total winding area, winding fill factor, mean length turn, and number of turns, among other things. For a comparison of the ferrite core and the permanent magnet hybrid core having similar winding areas, similar winding fill factors, similar mean length turns, the permanent magnet hybrid core may have lower de resistance by a factor of:

$$\frac{D C {R}_{h y b r i d}}{D C {R}_{ferr}} = \frac{{N}_{h y b r i d}^{2} {p}_{c u} l turn / ( {A}_{w} {k}_{u} )}{{N}_{f e r r}^{2} {p}_{c u} l turn / ( {A}_{w} {k}_{u} )} = \frac{{Φ}_{max , hybrid}^{2}}{{Φ}_{max , ferr}^{2}} - = {( \frac{{B}_{r} + {B}_{max}}{2 {B}_{r}} )}^{2} \qquad Eq . 11$$

where N=number of turns, pcu=resistivity of copper, l=mean length of the turns, Aw=total winding area, and Ku=winding fill factor.

As an example, if Bᵣ=1.2 T and Bₘₐₓ=OAT, the permanent magnet hybrid core may achieve a 0.44× lower de resistance compared to the ferrite core, or a 56% reduction, at a fixed energy storage and inductance, as determined based on Eq. 11.

iv. Design flexibility—The ac flux may largely flow in some subset of the soft magnetic materials in the core and not in the permanent magnetic material. Therefore, for the parts of the hybrid core such as the soft magnet that are exposed to ac flux, materials appropriate for low core losses at desired operation frequencies may be selected, allowing design and material flexibility. The permanent magnet may have multiple potential locations in the core, providing further flexibility in inductor design considerations.

In some embodiments, while adding a permanent magnet to a ferrite may improve saturation performance of the magnetic cores, the core losses may be higher at least due to less available ferrite fraction to carry the ac flux. However, because the permanent magnet

hybrid core is intended for de-dominated applications, an increase in core loss may have a negligible impact, if any, on the total loss.

It is to be appreciated that although magnetic core 300 is discussed and illustrated as being used in an inductor having a single winding, it may be used in transformers or coupled inductors having multiple windings. Additionally, or alternatively, magnetic core 300 may be designed to have multiple flux paths for the de flux and/or the ac flux. It is to be appreciated that different core geometries and permanent magnet locations may be implemented, as appropriate.

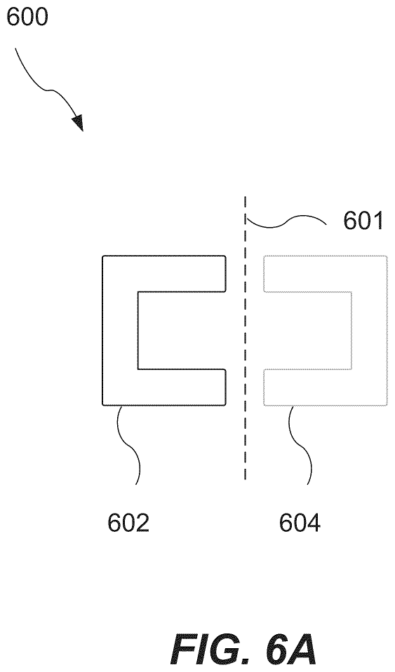

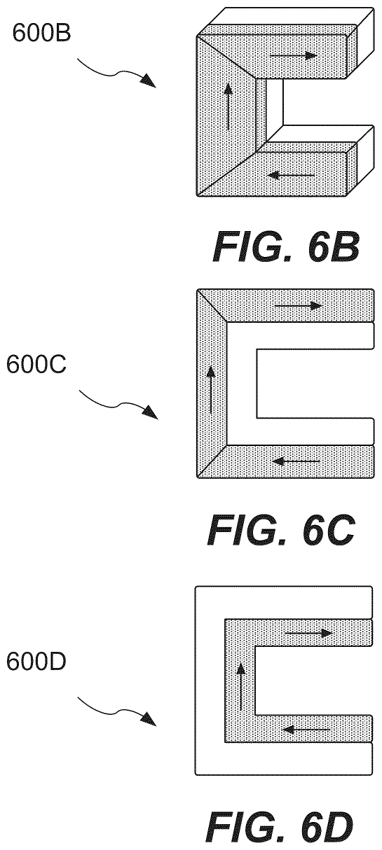

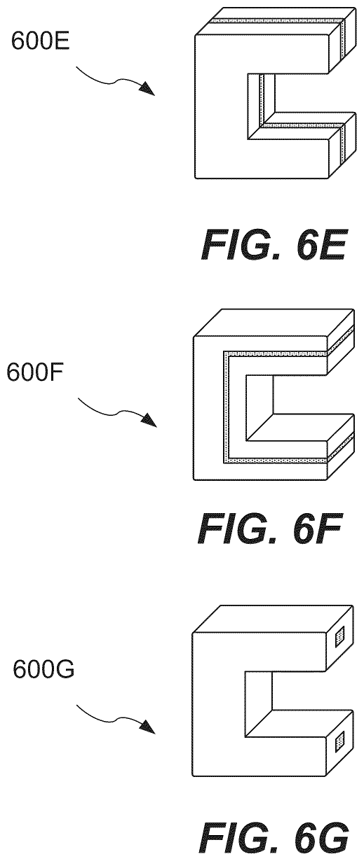

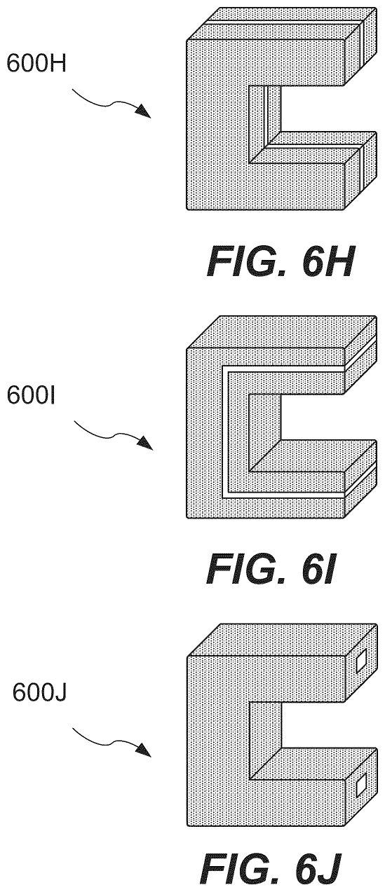

Reference is now made to FIG. 6A, which illustrates a schematic of an exemplary magnetic core 600, in accordance with embodiments of the present disclosure. Magnetic core 600 may include a double U-core geometry in which the core is split into two symmetric U-shaped halves 602 and 604 along a symmetry axis 601. As illustrated, magnetic core 600 may comprise a permanent magnet hybrid core including a soft magnetic material and a permanent magnetic material. In some embodiments, U-shaped halves 602 and 604 may be oriented such that they are separated by two gaps along symmetry axis 601. In some embodiments, one or both halves 602 and 604 may be made from a single piece or multiple pieces assembled together to form a substantially continuous piece with negligible space between them. In some embodiments, the cross-section of the U-shaped halves 602 and 604 may be uniform, or non-uniform, or uniformly or non-uniformly vary along its length. For example, the end faces may have a larger cross-section and the middle portions may have a narrower cross-section. Although not illustrated, it is appreciated that other implementations, cross-sections, geometries, or combinations thereof may be possible.

In some embodiments, a ratio of the minimum cross-sectional area of the first set of magnetic members, to a sum of the minimum cross-sectional area of the first set of magnetic members and a minimum cross-sectional area of the second set of magnetic members, is greater than 0.5, greater than 0.6, greater than 0.7, greater than 0.8, greater than 0.9, or greater than 0.95. The first set of magnetic members may include soft magnetic material members and the second set of magnetic members may include permanent magnetic material members.

FIGS. 6B-6J are schematic illustrations of exemplary implementations of the permanent magnet hybrid core in a parallel configuration, in accordance with embodiments

of the present disclosure. A “parallel implementation” or a “parallel configuration,” as used herein, refers to the location of the permanent magnet with reference to the location of the ferrite. In a parallel implementation, a permanent magnetic material may be located adjacent to an inner surface, or to an outer surface, or to both, of the soft magnetic material. In some parallel implementations, the permanent magnet may be enclosed or sandwiched in the soft magnetic material, or the soft magnetic material may be sandwiched or enclosed in the permanent magnetic material. In some embodiments, the permanent magnetic material may follow the soft magnetic material along a part of its length.

FIG. 6B illustrates a U-shaped half 600B of magnetic core 600 comprising a permanent magnetic material parallel and adjacent to the soft magnetic material such that the permanent magnetic material abuts the soft magnetic material. In such a configuration, the overall length of the soft magnetic material may be substantially similar or substantially the same as the overall length of the permanent magnetic material. The implementation represented by 600B may be analogous to magnetic core 300 of FIG. 3. FIG. 6C illustrates a U-shaped half 600C of magnetic core 600 comprising a permanent magnetic material surrounding the soft magnetic material on an outer surface such that an overall length of the permanent magnetic material is greater than the overall length of the soft magnetic material. FIG. 6D illustrates a U-shaped half 600D of magnetic core 600 comprising a permanent magnetic material surrounded by the soft magnetic material such that an overall length of the soft magnetic material is greater than the overall length of the permanent magnetic material.

In some embodiments, magnetic core 600 or a half of the magnetic core 600 may include a third magnetic member comprising a soft magnetic material. The second magnetic member may be located between the first and the third magnetic members. The second magnetic member may form a gap between the two end faces of the second magnetic member and the third magnetic member may form a third gap between the two end faces of third magnetic member, and the second and the third gaps may adjoin the first gap. FIGS. 6E and 6F illustrate a U-shaped half 600E and 600F of magnetic core 600, respectively, comprising a permanent magnetic material sandwiched between two members of soft magnetic material.

FIG. 6G illustrates a U-shaped half 600G of magnetic core 600 comprising a permanent magnetic material member enclosed within the soft magnetic material such that the permanent magnetic material member is surrounded on all sides by the soft magnetic material.

In some embodiments, a ratio of a sum of a minimum cross-sectional area of the first set of members and a minimum cross-sectional area of the third set of members, to a sum of the minimum cross-sectional area of the first set of members, the minimum cross-sectional area of the third set of members, and a minimum cross-sectional area of the second set of members, is greater than 0.5, greater than 0.6, greater than 0.7, greater than 0.8, greater than 0.9, or greater than 0.95. The first and third set of magnetic members may include soft magnetic material members and the second set of magnetic members may include permanent magnetic material members.

In some embodiments, magnetic core 600 or a half of the magnetic core 600 may include a third magnetic member comprising a permanent magnetic material. The second magnetic member may be located between the first and the third magnetic members. The second magnetic member may form a gap between the two end faces of the second magnetic member and the third magnetic member may form a third gap between the two end faces of third magnetic member, and the second and the third gaps may adjoin the first gap. FIGS. 6H and 61 illustrate a U-shaped half 600H and 6001 of magnetic core 600, respectively, comprising a soft magnetic material member sandwiched between two members of permanent magnetic material.

FIG. 6J illustrates a U-shaped half 600J of magnetic core 600 comprising a soft magnetic material enclosed within the permanent magnetic material such that the soft magnetic material is surrounded on all sides by the permanent magnetic material. It is to be appreciated that although FIGS. 6B-6J illustrate various parallel implementations of a double U-shaped core geometry, other implementations not illustrated may be possible as well. It is to be further appreciated that other geometries such as, but not limited to, a pot core geometry may be used as well.

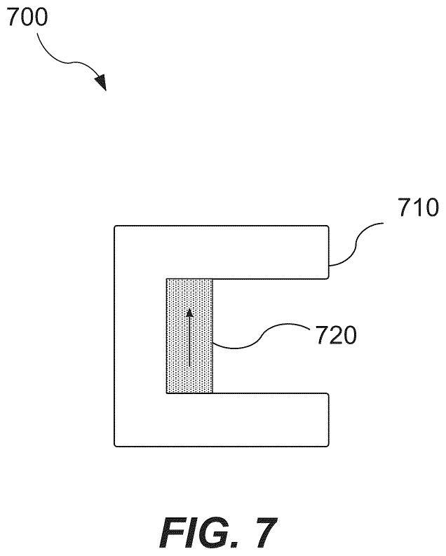

Reference is now made to FIG. 7, which illustrates an exemplary non-parallel implementation of one-half core 700 of a double U-shaped inductor core, in accordance with some embodiments of the present disclosure. A half core 700 may include a permanent magnetic material member 720 located partially along an inner surface of soft magnetic material member 710. In some embodiments, a permanent magnet hybrid core may include a combination of parallel, partially parallel, or non-parallel implementations, as appropriate. It is to be appreciated that the location of permanent magnetic material partially along the inner surface is just exemplary and non-limiting, and other implementations may be possible as well. For example, in the implementations shown in FIGS. 6B-6J, the permanent magnet may be located along only a portion of the length of soft magnet.

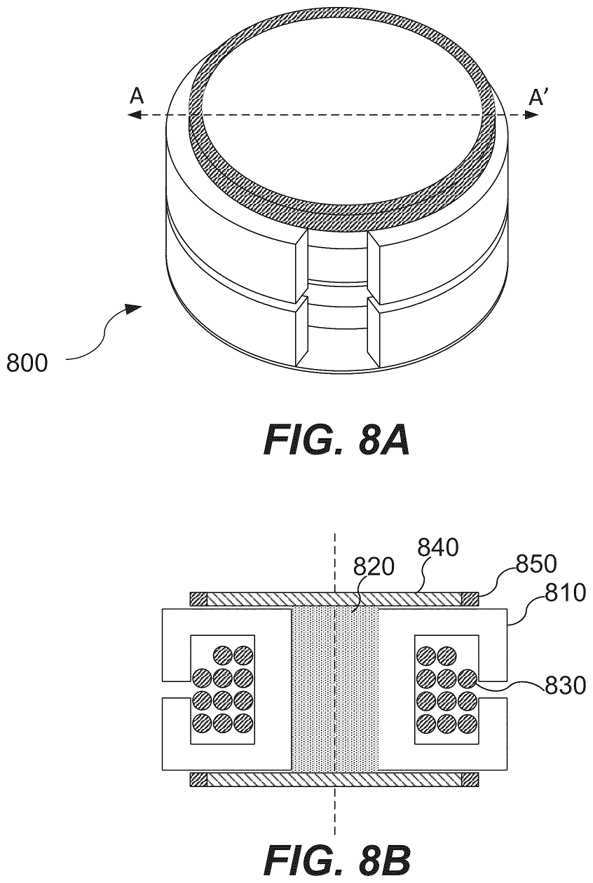

Reference is now made to FIG. 8A, which illustrates a perspective view of an exemplary permanent magnet hybrid core inductor 800, in accordance with some embodiments of the present disclosure. Inductor 800 may comprise a pot core geometry. FIG. 8B is a schematic illustration of a cross-section view of inductor 800 taken along A-A′, in accordance with some embodiments of the present disclosure. Inductor 800 may comprise a soft magnet 810, windings or coil 830 wound around soft magnet 810, a permanent magnet 820 placed in the center of the pot core, a flux guiding plate 840, and a shield 850.

Inductor 800 may comprise a permanent magnet hybrid core inductor. In some embodiments, inductor 800 may include permanent magnet 820 placed in the center of the pot core. Inductor 800 may further include flux guiding plate 840 at least on one end surface such as the top or the bottom surface of inductor 800. In a preferred embodiment, flux guiding plate 840 may be placed on the top and the bottom surface of inductor 800, as illustrated in FIG. 8B. Flux guiding plate 840 may guide the magnetic flux radially outward from permanent magnet 810. In some embodiments, flux guiding plate 840 may be made from a soft magnetic material having high permeability and high saturation flux density. In some embodiments, flux guiding plate 840 may be electrically conducting as well. In a preferred embodiment, flux guiding plate 840 may be made from a material such as, but not limited to, steel. The gap may be placed in the outer shell to encourage flux to return from flux guiding plate 840 through the top and bottom portions of soft magnet 810.

In some embodiments, inductor 800 may further include shield 850 made from an electrically conducting material including, but not limited to, copper, aluminum, silver, among other conducting materials. Shield 850 may be located between soft magnet 810 and flux guiding plate 840 to guide de flux paths. In some embodiments, flux guiding plate 840, when subjected to high frequency field may suffer from high losses including hysteresis and eddy-current losses. In some embodiments, while shield 850 may reduce the losses by, for example, blocking or reducing the ac winding flux entering flux guiding plate 840, it may allow de flux to flow between flux guiding plate 840 and soft magnet 810. In some embodiments, shield 850 may comprise an edge portion having a first thickness and a center portion having a second thickness different from the first thickness. In some embodiments, however, the edge of shield 850 may be thinner than the rest of shield 850. A thicker outer edge may reduce eddy current losses in shield 850. In some embodiments, shield 850 may be made from a single continuous piece of an electrically conducting material or from multiple pieces of electrically conducting material.

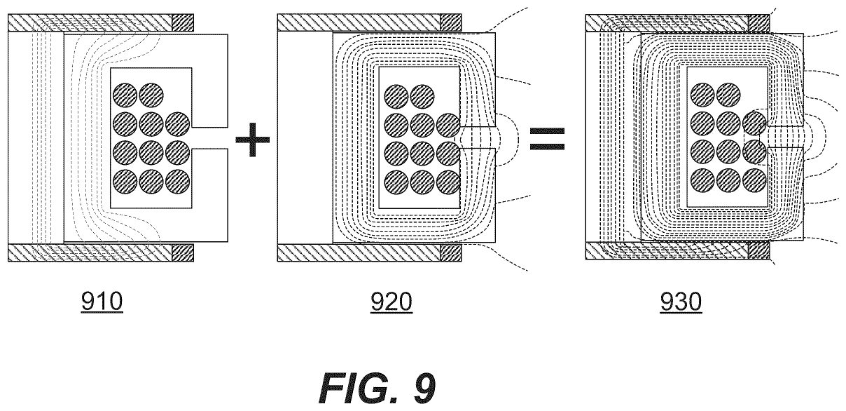

Reference is now made to FIG. 9, which illustrates winding and permanent magnet flux paths in inductor 800 of FIG. 8, in accordance with embodiments of the present disclosure. Configuration 910 illustrates the permanent magnet flux path in an axisymmetric cross-section of inductor 800. In configuration 910, the flux lines of permanent magnet 820 may be guided radially outward by flux guiding plate 840, and back towards soft magnet 810, thereby directing the flux lines through the top plate of the pot core of inductor 800, as well as through its center post. Configuration 920 illustrates the de winding flux flowing in soft magnet 810 and across the outer gap between two end faces of soft magnet 810 without the effect of the PM (e.g., with the PM replaced by a non-magnetic material). Configuration 930 illustrates a combination of permanent magnet flux lines and de winding flux lines in inductor 800.

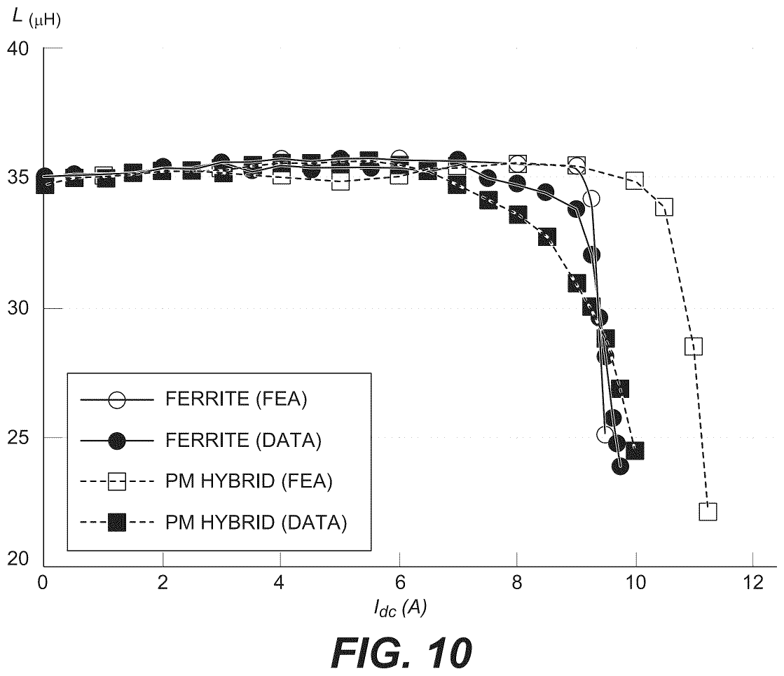

Reference is now made to FIG. 10, which illustrates simulated and experimental saturation behavior data comparison between a permanent magnet hybrid core inductor and a pure ferrite core inductor, in accordance with some embodiments of the present disclosure.

Simulations were performed using the ANSYS Maxwell software with the 2D cylindrical finite elemental analysis (FEA) method. As illustrated in FIG. 10, for a 30% allowable drop in inductance, the permanent magnet hybrid core inductor prototype achieved a de current of 11.1 A in simulation and 10.0 A in experiment. This discrepancy may be explained by the physical implementation of the off-the-shelf permanent magnets, which include a stack of permanent magnets each coated with a nickel coating. The coating may introduce gaps between the permanent magnets and flux guiding plate 840 and may also provide a magnetic shunt path for the permanent magnet flux, thereby reducing the amount of permanent magnet flux opposing the de winding flux in soft magnet 810.

Based on the simulations and experimental data, the permanent magnet hybrid core inductor outperformed the pure ferrite inductor. For example, for an allowable 30% inductance drop, in simulation, the permanent magnet hybrid core inductor achieved a 34% reduction in de resistance at 17% greater maximum de current, and a 37% greater energy storage. Experimental results were consistent with the simulations.

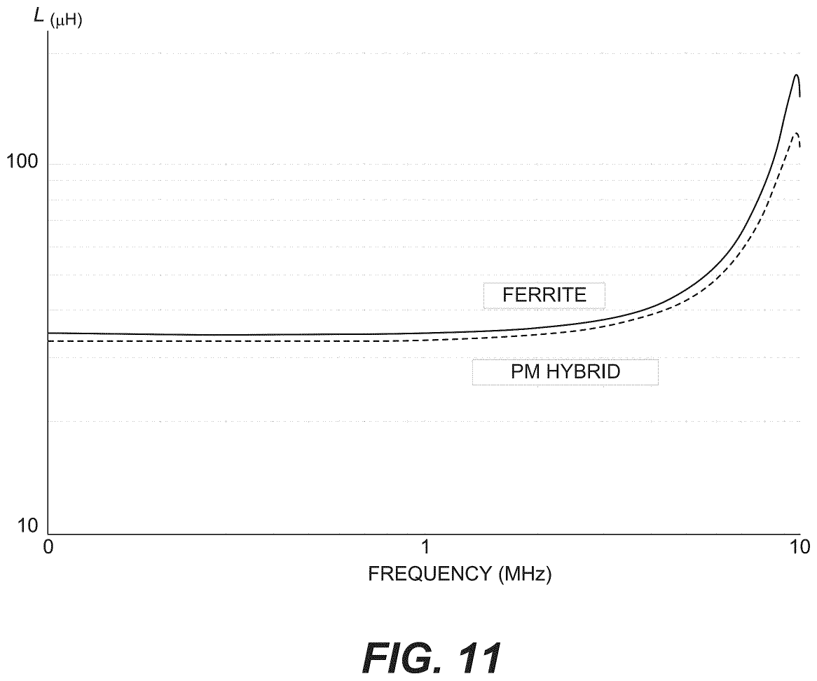

FIG. 11 represents a data plot of the frequency response of the inductance of a pure ferrite core inductor compared with the permanent magnet hybrid core inductor. As shown, the ferrite and the permanent magnet hybrid core inductors demonstrate a substantially similar frequency response of the inductance. As an example, at 1 MHz, the inductances of the ferrite core inductor and the permanent magnet hybrid core inductor are both 35.1 μH.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The embodiments may further be described using the following clauses:
1. A magnetic core, comprising:
   a first set of members comprising a soft magnetic material, the first set of members forming a first gap between two end faces of the first set of members; and
   a second set of members comprising a permanent magnetic material and located adjacent to the first set of members;
   wherein the second set of members provides at least a partially parallel path to the first set of members for flow of magnetic flux lines.
2. The magnetic core of clause 1, wherein the first set of members consists of one soft magnetic member.
3. The magnetic core of clause 1, wherein the first set of members consists of two soft magnetic members, each soft magnetic member having a U-shape and providing one of the two end faces of the first set of members.
4. The magnetic core of clause 1, wherein the first and second set of members are configured such that the flow of magnetic flux lines in the second set of members opposes the flow of magnetic flux lines in the first set of members induced by current flowing through an electrical conductor wound around at least the first set of members.
5. The magnetic core of clause 4, wherein the first and second set of members are configured such that the flow of magnetic flux lines in the second set of members opposes the flow of magnetic flux lines in the first set of members induced by current flowing through an electrical conductor wound around the first set of members and the second set of members.
6. The magnetic core of clause 1, wherein the first and second set of members are configured such that the flow of magnetic flux lines through the first set of members induced by current flowing through an electrical conductor wound around at least the first set of members is at least 50 times more than through the second set of members, as determined by finite element modeling.
7. The magnetic core of clause 1, wherein the second set of members provides at least a partially parallel path to the first set of members for flow of magnetic flux lines between the two end faces of the first set of members.
8. The magnetic core of clause 1, wherein the second set of members provides a substantially fully parallel path to the first set of members for flow of magnetic flux lines.
9. The magnetic core of clause 1, wherein the soft magnetic material is a ferrite.
10. The magnetic core of clause 1, wherein the soft magnetic material is a powder core material.
11. The magnetic core of clause 1, wherein the first gap is filled with air.
12. The magnetic core of clause 1, wherein the first air gap is filled with a material having magnetic permeability lower than that of the first set of members.
13. The magnetic core of clause 1, wherein at least one member of the second set of members abuts at least one member of the first set of members.
14. The magnetic core of clause 1, wherein the second set of members forms a second gap between two end faces of the second set of members, the second gap adjoining the first gap.
15. The magnetic core of clause 14, wherein the second set of members consists of two permanent magnetic members, each permanent magnetic member having a U-shape and providing one of the two end faces of the second set of members.
16. The magnetic core of clause 1, wherein an overall length of the second set of members is substantially the same as an overall length of the first set of members.
17. The magnetic core of clause 1, wherein an overall length of the second set of members is less than an overall length of the first set of members.
18. The magnetic core of clause 1, wherein an overall length of the second set of members is greater than an overall length of the first set of members.
19. The magnetic core of clause 1, wherein at least one member of the second set of members is located adjacent to an outer surface of at least one member of the first set of members.
20. The magnetic core of clause 1, wherein at least one member of the second set of members is located adjacent to an inner surface of at least one member of the first set of members.
21. The magnetic core of clause 1, wherein at least one member of the second set of members is located in a hollow space provided by at least one member of the first set of members.
22. The magnetic core of clause 1, wherein at least one member of the first set of members is located in a hollow space provided by at least one member of the second set of members.
23. The magnetic core of clause 1, wherein a ratio of a minimum cross-sectional area of the first set of members, to a sum of the minimum cross-sectional area of the first set of members and a minimum cross-sectional area of the second set of members, is greater than 0.5.
24 The magnetic core of clause 23, wherein the ratio is greater than 0.6.
25. The magnetic core of clause 24, wherein the ratio is greater than 0.7.
26. The magnetic core of clause 25, wherein the ratio is greater than 0.8.
27. The magnetic core of clause 26, wherein the ratio is greater than 0.9.
28. The magnetic core of clause 27, wherein the ratio is greater than 0.95.
29. The magnetic core of clause 1, further comprising a third set of members comprising a soft magnetic material, wherein the second set of members is located between the first set of members and the third set of members.
30. The magnetic core of clause 29, wherein the second set of members forms a second gap between two end faces of the second set of members, wherein the third set of members forms a third gap between two end faces of the third set of members, and wherein the second and third gaps both adjoin the first gap.
31. The magnetic core of clause 29, wherein a ratio of a sum of a minimum cross-sectional area of the first set of members and a minimum cross-sectional area of the third set of members, to a sum of the minimum cross-sectional area of the first set of members, the minimum cross-sectional area of the third set of members, and a minimum cross-sectional area of the second set of members, is greater than 0.5.
32. The magnetic core of clause 31, wherein the ratio is greater than 0.6.
33. The magnetic core of clause 32, wherein the ratio is greater than 0.7.
34 The magnetic core of clause 33, wherein the ratio is greater than 0.8.
35. The magnetic core of clause 34, wherein the ratio is greater than 0.9.
36 The magnetic core of clause 35, wherein the ratio is greater than 0.95.
37. The magnetic core of clause 1, further comprising a third set of members comprising a permanent magnetic material, wherein the first set of members is located between the second set of members and the third set of members.
38. The magnetic core of clause 37, wherein the second set of members forms a second gap between two end faces of the second set of members, wherein the third set of members forms a third gap between two end faces of the third set of members, and wherein the second and third gaps both adjoin the first gap.
39. The magnetic core of clause 37, wherein a ratio of a sum of a minimum cross-sectional area of the first set of members, to a sum of the minimum cross-sectional area of the first set of members, a minimum cross-sectional area of the second set of members, and a minimum cross-sectional area of the third set of members, is greater than 0.5.
40. The magnetic core of clause 39, wherein the ratio is greater than 0.6.
41. The magnetic core of clause 40, wherein the ratio is greater than 0.7.
42. The magnetic core of clause 41, wherein the ratio is greater than 0.8.
43 The magnetic core of clause 42, wherein the ratio is greater than 0.9.
44. The magnetic core of clause 43, wherein the ratio is greater than 0.95.
45. The magnetic core of clause 1, wherein the first set of members comprises a plurality of soft magnetic materials.
46. The magnetic core of clause 1, further comprising another soft magnetic member having higher saturation flux density than the first set of members, the another soft magnetic member configured to guide magnetic flux flowing through at least one of the first set of members and the second set of members.
47. The magnetic core of clause 46, further comprising an electrically conducting shield, the electrically conducting shield located adjacent to the another soft magnetic member and to at least one member of the first set of members.
48. The magnetic core of clause 29, further comprising another soft magnetic member having higher saturation flux density than the first set of members and the third set of members, the another soft magnetic member configured to guide magnetic flux flowing through at least one of the first set of members, the second set of members, and the third set of members.
49. The magnetic core of clause 48, further comprising an electrically conducting shield, the electrically conducting shield located adjacent to the another soft magnetic member, and to at least one member of the first set of members or at least one member of the third set of members.
50. The magnetic core of clause 37, further comprising another soft magnetic member having higher saturation flux density than the first set of members, the another soft magnetic member configured to guide magnetic flux flowing through at least one of the first set of members, the second set of members, and the third set of members.
51. The magnetic core of clause 50, further comprising an electrically conducting shield, the electrically conducting shield located adjacent to the another soft magnetic member and to at least one member of the first set of members.
52. The magnetic core of clause 47, wherein the electrically conducting shield comprises an edge portion having a first thickness and a center portion having a second thickness different from the first thickness.
53. The magnetic core of clause 49, wherein the electrically conducting shield comprises an edge portion having a first thickness and a center portion having a second thickness different from the first thickness.
54. The magnetic core of clause 51, wherein the electrically conducting shield comprises an edge portion having a first thickness and a center portion having a second thickness different from the first thickness.
55. A magnetic core, comprising:
   a permanent magnet having a curved surface; and
   a soft magnetic member located adjacent to the curved surface of the permanent magnet;
   wherein the soft magnetic member forms a first gap between two end faces of the soft magnetic member,
   wherein the soft magnetic member provides a hollow space for winding an electrical conductor around the permanent magnet, and
   wherein the permanent magnet provides at least a partially parallel path to the soft magnetic member for flow of magnetic flux lines.
56. The magnetic core of clause 55, wherein the flow of magnetic flux lines in the permanent magnet opposes the flow of magnetic flux lines in the soft magnetic member induced by current flowing through the electrical conductor.
57. The magnetic core of clause 55, wherein the soft magnetic member and the permanent magnet are configured such that the flow of magnetic flux lines through the soft magnetic member induced by current flowing through the electrical conductor is at least 50 times more than through the permanent magnet, as determined by finite element modeling.
58. The magnetic core of clause 55, wherein the permanent magnet provides at least a partially parallel path to the soft magnetic member for flow of magnetic flux lines between the two end faces of the soft magnetic member.
59. The magnetic core of clause 55, wherein the permanent magnet provides a substantially fully parallel path to the soft magnetic member for the flow of magnetic flux lines.
60. The magnetic core of clause 55, wherein the soft magnetic material is a ferrite.
61. The magnetic core of clause 55, wherein the soft magnetic material is a powder core material.
62. The magnetic core of clause 55, wherein the first gap is filled with air.
63. The magnetic core of clause 55, wherein the first air gap is filled with a material having magnetic permeability lower than that of the soft magnetic member.
64. The magnetic core of clause 55, wherein at least a portion of the soft magnetic member abuts at least a portion of the permanent magnet.
65. The magnetic core of clause 64, wherein the soft magnetic member abuts the curved surface of the permanent magnet.
66. The magnetic core of clause 55, wherein the soft magnetic member is configured so that the electrical conductor also winds around a portion of the soft magnetic member.
67. The magnetic core of clause 55, further comprising a second soft magnetic member, the second soft magnetic member configured to guide magnetic flux from the permanent magnet to the soft magnetic member.
68. The magnetic core of clause 67, further comprising an electrically conducting shield, the electrically conducting shield located adjacent to the second soft magnetic member and the soft magnetic member.
69. The magnetic core of clause 68, wherein the electrically conducting shield comprises an edge portion having a first thickness and a center portion having a second thickness different from the first thickness.
70. An inductor, comprising:
   an electrical conductor wound around a magnetic core, wherein the magnetic core is as claimed in any of clauses 1-69.
71. An apparatus, comprising:
   a switching voltage regulator including an inductance, the inductance comprising an electrical conductor wound around a magnetic core, wherein the magnetic core is as claimed in any of clauses 1-69.
72. The apparatus of clause 71, wherein a switching frequency of the switching voltage regulator is at least 1 MHz.
73. An apparatus, comprising:
   a power conversion circuit including an inductance, the inductance comprising an electrical conductor wound around a magnetic core, wherein the magnetic core is as claimed in any of claims 1-69.
74. An apparatus, comprising:
   a power conversion circuit including a switched capacitor circuit and a switching regulator, the switching regulator including an inductance, the inductance comprising an electrical conductor wound around a magnetic core, wherein the magnetic core is as claimed in any of claims 1-69.
75. The apparatus of claim 74, wherein a switching frequency of the switching regulator is at least 1 MHz.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A magnetic core, comprising:
a first set of members comprising a soft magnetic material, the first set of members forming a first gap between two end faces of the first set of members; and
a second set of members comprising a permanent magnetic material and located adjacent to the first set of members;
wherein the second set of members provides at least a partially parallel path to the first set of members for flow of magnetic flux lines.

2. The magnetic core of claim 1, wherein the first set of members consists of one soft magnetic member.

3. The magnetic core of claim 1, wherein the first set of members consists of two soft magnetic members, each soft magnetic member having a U-shape and providing one of the two end faces of the first set of members.

4. The magnetic core of claim 1, wherein the first and second set of members are configured such that the flow of magnetic flux lines in the second set of members opposes the flow of magnetic flux lines in the first set of members induced by current flowing through an electrical conductor wound around at least the first set of members.

5. The magnetic core of claim 4, wherein the first and second set of members are configured such that the flow of magnetic flux lines in the second set of members opposes the flow of magnetic flux lines in the first set of members induced by current flowing through an electrical conductor wound around the first set of members and the second set of members.

6. The magnetic core of claim 1, wherein the first and second set of members are configured such that the flow of magnetic flux lines through the first set of members induced by current flowing through an electrical conductor wound around at least the first set of members is at least 50 times more than through the second set of members, as determined by finite element modeling.

7. The magnetic core of claim 1, wherein the second set of members provides at least a partially parallel path to the first set of members for flow of magnetic flux lines between the two end faces of the first set of members.

8. The magnetic core of claim 1, wherein the second set of members provides a substantially fully parallel path to the first set of members for flow of magnetic flux lines.

9. The magnetic core of claim 1, wherein the soft magnetic material is a ferrite.

10. The magnetic core of claim 1, wherein the soft magnetic material is a powder core material.

11. The magnetic core of claim 1, wherein the first gap is filled with air.

12. The magnetic core of claim 1, wherein the first air gap is filled with a material having magnetic permeability lower than that of the first set of members.

13. The magnetic core of claim 1, wherein at least one member of the second set of members abuts at least one member of the first set of members.

14. The magnetic core of claim 1, wherein the second set of members forms a second gap between two end faces of the second set of members, the second gap adjoining the first gap.

15. The magnetic core of claim 14, wherein the second set of members consists of two permanent magnetic members, each permanent magnetic member having a U-shape and providing one of the two end faces of the second set of members.

16. The magnetic core of claim 1, wherein an overall length of the second set of members is substantially the same as an overall length of the first set of members.

17. The magnetic core of claim 1, wherein an overall length of the second set of members is less than an overall length of the first set of members.

18. The magnetic core of claim 1, wherein an overall length of the second set of members is greater than an overall length of the first set of members.

19. The magnetic core of claim 1, wherein at least one member of the second set of members is located adjacent to an outer surface of at least one member of the first set of members.

20. The magnetic core of claim 1, wherein at least one member of the second set of members is located adjacent to an inner surface of at least one member of the first set of members.

21. The magnetic core of claim 1, wherein at least one member of the second set of members is located in a hollow space provided by at least one member of the first set of members.

22. The magnetic core of claim 1, wherein at least one member of the first set of members is located in a hollow space provided by at least one member of the second set of members.

23. The magnetic core of claim 1, wherein a ratio of a minimum cross-sectional area of the first set of members, to a sum of the minimum cross-sectional area of the first set of members and a minimum cross-sectional area of the second set of members, is greater than 0.5.

24. The magnetic core of claim 1, further comprising a third set of members comprising a soft magnetic material, wherein the second set of members is located between the first set of members and the third set of members.

25. The magnetic core of claim 24, wherein the second set of members forms a second gap between two end faces of the second set of members, wherein the third set of members forms a third gap between two end faces of the third set of members, and wherein the second and third gaps both adjoin the first gap.

26. The magnetic core of claim 24, wherein a ratio of a sum of a minimum cross-sectional area of the first set of members and a minimum cross-sectional area of the third set of members, to a sum of the minimum cross-sectional area of the first set of members, the minimum cross-sectional area of the third set of members, and a minimum cross-sectional area of the second set of members, is greater than 0.5.

27. The magnetic core of claim 1, further comprising a third set of members comprising a permanent magnetic material, wherein the first set of members is located between the second set of members and the third set of members.

28. The magnetic core of claim 27, wherein the second set of members forms a second gap between two end faces of the second set of members, wherein the third set of members forms a third gap between two end faces of the third set of members, and wherein the second and third gaps both adjoin the first gap.

29. The magnetic core of claim 27, wherein a ratio of a sum of a minimum cross-sectional area of the first set of members, to a sum of the minimum cross-sectional area of the first set of members, a minimum cross-sectional area of the second set of members, and a minimum cross-sectional area of the third set of members, is greater than 0.5.

30. The magnetic core of claim 1, wherein the first set of members comprises a plurality of soft magnetic materials.

31. The magnetic core of claim 1, further comprising another soft magnetic member having higher saturation flux density than the first set of members, the another soft magnetic member configured to guide magnetic flux flowing through at least one of the first set of members and the second set of members.

32. The magnetic core of claim 31, further comprising an electrically conducting shield, the electrically conducting shield located adjacent to the another soft magnetic member and to at least one member of the first set of members.

33. The magnetic core of claim 24, further comprising another soft magnetic member having higher saturation flux density than the first set of members and the third set of members, the another soft magnetic member configured to guide magnetic flux flowing through at least one of the first set of members, the second set of members, and the third set of members.

34. The magnetic core of claim 33, further comprising an electrically conducting shield, the electrically conducting shield located adjacent to the another soft magnetic member, and to at least one member of the first set of members or at least one member of the third set of members.

35. The magnetic core of claim 27, further comprising another soft magnetic member having higher saturation flux density than the first set of members, the another soft magnetic member configured to guide magnetic flux flowing through at least one of the first set of members, the second set of members, and the third set of members.

36. The magnetic core of claim 35, further comprising an electrically conducting shield, the electrically conducting shield located adjacent to the another soft magnetic member and to at least one member of the first set of members.

37. The magnetic core of claim 32, wherein the electrically conducting shield comprises an edge portion having a first thickness and a center portion having a second thickness different from the first thickness.

38. The magnetic core of claim 34, wherein the electrically conducting shield comprises an edge portion having a first thickness and a center portion having a second thickness different from the first thickness.

39. The magnetic core of claim 36, wherein the electrically conducting shield comprises an edge portion having a first thickness and a center portion having a second thickness different from the first thickness.
